(19) United States
(12) Patent Application Publication
(10) Pub. No.: US 2026/0342782 A1
(43) Pub. Date: Oct. 29, 2026

(54) SECURED WITNESS ONBOARDING IN A ZERO-TRUST HIGH-AVAILABILITY CLUSTER

(71) Applicant: Dell Products L.P., Round Rock, TX (US)

(72) Inventors: Emmanuel Andre, Singapore (SG); Jia Yuan Chia, Singapore (SG); Mahesh Babu Ramaiah, Bangalore (IN); Chuan Tian Chuah, Singapore (SG); Pankaj Kumar Thapa, Bangalore (IN)

(73) Assignee: Dell Products L.P., Round Rock, TX (US)

(21) Appl. No.: 19/186,755

(22) Filed: Apr. 23, 2025

(51) Int. Cl. H04L 9/40

(52) U.S. Cl. CPC H04L 63/0823

(57) ABSTRACT

Systems and methods for secure witness onboarding in zero-trust high-availability clusters are disclosed. A cluster is configured via a management system, which then deploys a witness entity and establishes secure communication channels using certificates from a witness certificate signing request. This approach ensures high availability and data integrity by enabling software-based witnesses to act as quorum witnesses. The witness entity can be a virtual machine or container-based application. The method includes generating and periodically refreshing a witness passphrase to maintain secure communication. The system includes a management system and servers designed to manage operations and monitor the health of the witness entity.

### BACKGROUND

As the value and use of information continues to increase, individuals and businesses seek additional ways to process and store information. One option is an Information Handling System (IHS). An IHS generally processes, compiles, stores, or communicates information or data for business, personal, or other purposes. Technology and information handling needs and requirements can vary between different applications. Thus, IHSs can also vary regarding what information is handled, how the information is handled, how much information is processed, stored, or communicated, and how quickly and efficiently the information can be processed, stored, or communicated. The variations in IHSs allow systems to be general or configured for a specific user or specific use such as financial transaction processing, airline reservations, enterprise data storage, internet of things (IOT) monitoring and communications, or global communications. In addition, IHSs can include a variety of hardware and software resources that can be configured to process, store, and communicate information and can include one or more computer systems, graphics interface systems, data storage systems, and networking systems. IHSs can also implement various virtualized architectures. Data communications among information handling systems may be via networks that are wired, wireless, optical or some combination.

IHSs can be used in a distributed environment as compute endpoints and edge devices. Example edge devices include applications running in a retail store, such as point of sale device, a gateway, a compute or storage device not operating in a datacenter, remote industrial sensor and monitoring equipment, or deployed telecommunications equipment. Edge devices may be vulnerable to attack due to being in a remote location and/or a lack of physical security. Edge devices often service critical data. The edge devices may run autonomously without network connectivity to a central control plane for an extended period of time. In these architectures, it is important to protect the data stored on remote edge devices from compromise.

Security is an important aspect the IHSs operation. Potential points of attack may exist in an IHS for a malicious party to steal data, modify data, and/or engage in other illicit activities. To mitigate the potential for such attacks, a variety of techniques may be employed to enhance the security of IHSs. For example, secure communication channels between the various components of an IHS may be established, such as those using Transport Layer Security (TLS) and/or Secure Sockets Layer (SSL) protocols. As another example, password and/or other credential-based authentication between the various components of an IHS may be used to establish trust. In yet another example, non-password secure communication techniques that do not necessarily require user input may be applied. In such cases, to enable non-password administrative addressing to an endpoint, an authentication technique, such as a Fast ID Online (FIDO) protocol may be used to further protect endpoint secrets with certain cryptographic methods. The FIDO Device Onboard (FDO) standard may use the FIDO protocol to automate an initial registration operation of a device.

### SUMMARY

Embodiments are directed to a secure method for deploying and onboarding software-based witnesses to a compute endpoint high-availability cluster. The method ensures that the software-based witnesses can serve as quorum witnesses without introducing unnecessary security risks. Direct network access and indirect network access scenarios are addressed. With direct network access between a management system, compute endpoints, and a software-based witness, a fully automated, zero-touch solution is available via a management system to compute endpoints secure channel. When only indirect network access is available between the management system and the software-based witness, addition of the witness to the cluster is accomplished manually by a user.

In one configuration, a method includes configuring a cluster of compute endpoints using a management system, deploying a witness entity, and establishing a secure communication channel between the management system and the witness entity. The method further comprises generating a witness certificate signing request (CSR) on the witness entity, having the management system sign this request to create a witness-cluster certificate, and providing both the witness-cluster certificate and a cluster certificate to the witness entity. Secure communication channels are then established between the witness entity and the compute endpoints using these certificates. The witness entity is then joined to the cluster, which allows for consensus algorithms to be executed. The witness entity is implemented as either a virtual machine–based or container–based software application, for example.

In another configuration, a method includes configuring a cluster of compute endpoints using a management system and separately deploying a witness entity by a user. The witness entity does not have a secure communication channel with the management system. The method includes generating a witness certificate signing request on the witness entity and then providing the request to the management system by the user, such as through a user interface. The management system signs the request to form a witness-cluster certificate, after which both the witness-cluster certificate and a cluster certificate are provided to the witness entity by the user. The witness entity may then establish secure communication channels with the compute endpoints in the cluster.

In another embodiment, the disclosure includes a system comprising a management system and a plurality of servers in communication with the management system. The management system is configured with a processor and memory executing instructions that cause the management system to configure a cluster comprising two or more servers, deploy a witness entity, retrieve a witness certificate signing request directly from the witness entity, and sign the request to create a witness-cluster certificate. The system then provides the witness-cluster certificate and a cluster certificate to the witness entity, thereby establishing secure communication channels between the witness entity and the servers. In some embodiments, one or more servers are further configured to generate a witness passphrase, periodically refresh the passphrase, and broadcast the passphrase to both the servers and the witness entity, as well as to receive heartbeat messages from the witness entity and monitor the health and status of the witness entity.

### BRIEF DESCRIPTION OF THE DRAWINGS

Having thus described the invention in general terms, reference will now be made to the accompanying drawings, which are not necessarily drawn to scale, and wherein:

FIG. 1 illustrates FIDO onboarding of Compute Endpoints (CE) to a Management System (MS).

FIGS. 2A-2C illustrate a process for establishing secure communications among multiple ECEs via Mutual Transport Layer Security (mTLS).

FIGS. 3A-3J illustrate a full automated process for adding a witness entity to a high-availability cluster where direct network access is available among the MS, CEs, and witness.

FIGS. 4A-4G illustrate a manual process for adding a witness entity to a high-availability cluster where indirect network access is available between the MS, CEs, and witness.

FIG. 5 shows an example of an Information Handling System (IHS) configured to implement systems and methods as described herein for establishing mutual trust between a software-based witness and other CEs of a high-availability cluster and for ensuring that all entities forming the HA cluster can communicate securely and reliably without introducing unnecessary security risks.

### DETAILED DESCRIPTION

The invention now will be described more fully hereinafter with reference to the accompanying drawings. This invention may, however, be embodied in many different forms and should not be construed as limited to the embodiments set forth herein. Rather, these embodiments are provided so that this disclosure will be thorough and complete, and will fully convey the scope of the invention to those skilled in the art. One skilled in the art may be able to use the various embodiments of the invention.

The Fast IDentity Online (FIDO) Alliance has promulgated a set of security-focused technologies and protocols intended to simplify and enhance cybersecurity. Information handling systems, such as server devices and/or other computing devices, may benefit by performing authentication via the FIDO Device Onboarding (FDO) protocol. The embodiments disclosed herein provide a solution to implement secured witness onboarding in a zero-trust high-availability (HA) Cluster. An HA Cluster is a group of compute endpoints supporting software applications that can be reliably utilized with a minimum amount of downtime. The HA Cluster operates using high-availability software to harness redundant computers in groups or clusters that provide continued service when system components fail. This provides device and data security as well as guaranteed data privacy in the process. An HA Cluster may comprise a number of Compute Endpoints (CE) centrally managed by a Management System (MS). Typically, an MS is an advanced server management software providing a centralized platform for controlling CEs and workloads on those endpoints. The CEs may include servers, gateways or computers (i.e., hardware devices plus associated software). In some embodiments, the MS may be an Edge Orchestrator (EO) and the CEs may be Edge Compute Endpoints (ECE).

In an example use of FIDO protocols, a computing device manufacturer manufactures a CE using the FDO Device Initialization (DI) (FDO-DI) protocol, which provides for the generation of a public/private key pair, secure storage of the private key in the CE device, and inclusion of the public key in a digital ownership voucher that defines an “owner” of the CE. The digital ownership voucher is configured to be transferred to using public/private key signing techniques to different “owners” of the CE as it moves through the supply chain (e.g., among various resellers known the art) to an end user that becomes the “last owner” of the CE.

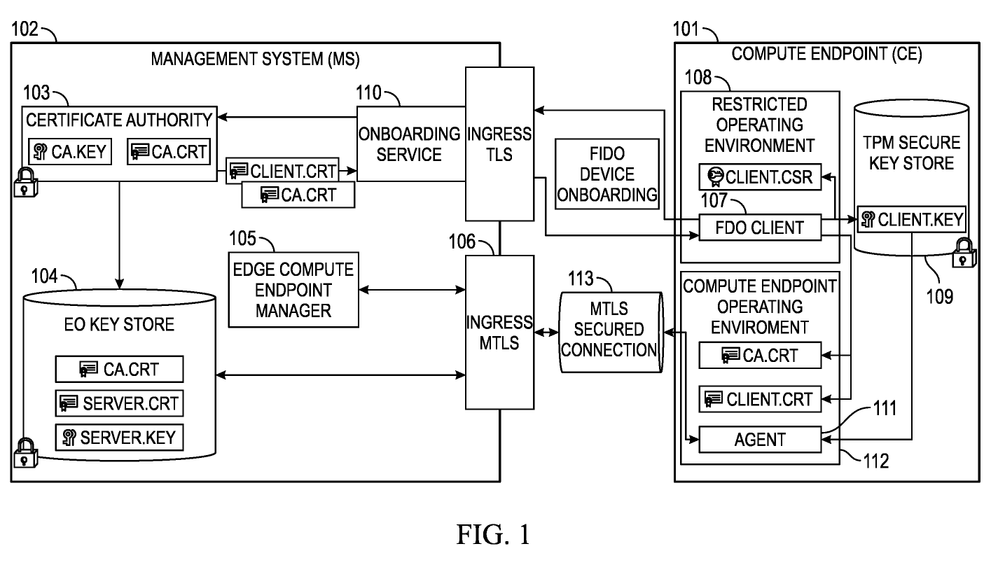

FIG. 1 illustrates FIDO onboarding of compute endpoint (CE) 101 to a management system (MS) 102. At the end of the secure onboarding, a secure channel is used to setup Mutual Transport Layer Security (mTLS) to secure the CE 101 to MS 102 communications.

Certificate Authority (CA) 103 on MS 102 generates a CA certificate (ca.crt) and CA key (ca.key). A server certificate (server.crt) and server key (server.key) are also generated and are saved in an MS key store 104 along with the CA certificate.

A compute endpoint manager 105 manages an ingress controller or load balancer 106 where incoming TLS connections are terminated. The ingress controller 106 is configured to use the CA certificate, the server private key, and the server certificate from the MS key store 104.

On the CE 101, a secure device onboard (SDO) client 107 generates a client private key (client.key) within a restricted operating environment 108, such as a Trusted Platform Module (TPM). The client key is stored in a TPM secure key store 109. The SDO client 107 also generates a client certificate signing request (CSR) (client.csr). SDO client 107 sends the client CSR to the MS certificate authority 103. The SDO client 107 follows the FIDO device-onboarding specifications.

Working with an onboarding service 110, the MS certificate authority 103 generates a client certificate (client.crt) using the client CSR along with the CA certificate and the CA key. The MS certificate authority 103 sends the client certificate along with its CA certificate back to CE 101.

The SDO client 107 provides the CA certificate and client certificate to an agent 111 running in compute endpoint operating environment 112. The agent 111 uses TPM, the CA certificate, and the client certificate to establish an mTLS secure channel 113 between CE 101 and MS 102. The TPM internally uses the securely stored client private key for encryption/signing. Therefore, the client private key never leaves the TPM module.

The implementation illustrated in FIG. 1 is fully secure and zero touch, which means that the user installing a CE 101 just needs to plug into the network and the CE 101 will be onboarded. After multiple CEs are onboarded onto the MS, an HA cluster is created by the MS sending required commands to the CEs.

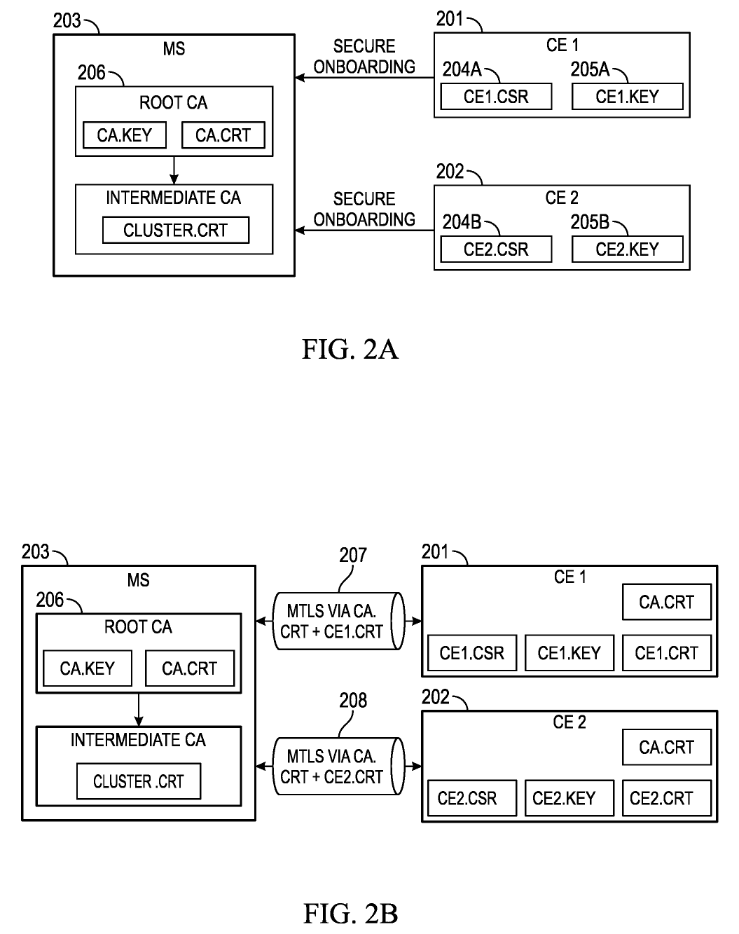

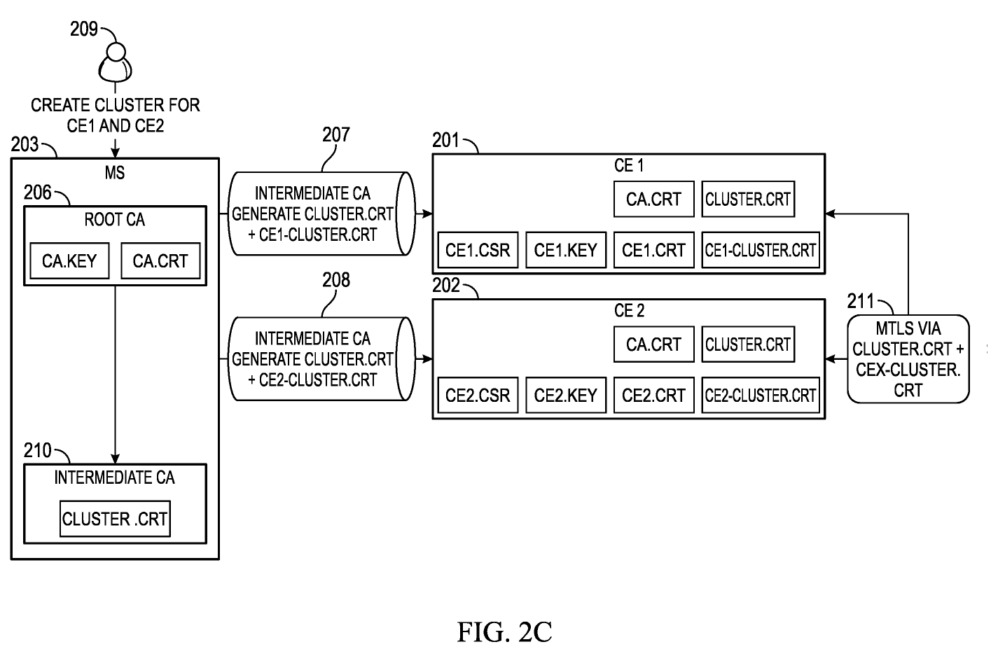

FIGS. 2A-2C illustrate a process for establishing secure communications among multiple CEs in an HA cluster via mTLS. Firstly, as shown in FIG. 2A, CEs 201 and 202 are onboarded to MS 203 via FIDO Secure Device Onboarding (SDO) as discussed in reference to FIG. 1. Each CE 201 and 202 has a CE certificate signing request (CE.csr) 204 and a CE private key (CE.key) 205. A root certificate authority 206 on MS 203 generates a CA key (ca.key) and CA certificate (ca.crt).

As shown in FIG. 2B, during the SDO process, the CEs 201 and 202 setup mTLS connections 207 and 208 with MS 203 as discussed in reference to FIG. 1.

As shown in FIG. 2C, a user 209, such as a network administrator, creates a cluster between the CEs 201 and 202 via MS 203. During the cluster creation process, CEs 201 and 202 will send their certificate signing request (client.csr) to MS 203 again via the established mTLS channels 207 and 208, respectively. An intermediate cluster authority 210 in MS 203 generates a cluster certificate (cluster.crt). The MS 203 uses the CE certificate signing requests (client.csr) and the cluster certificate to generate a CE-cluster certificate (CE-cluster.crt) for each CE 201 and 202. The MS 203 returns the respective certificates to each CE 201, 202 along with the cluster certificate. With the cluster certificate and the respective CE-cluster certificate, the CEs 201 and 202 establish direct mTLS communication 211 with each other.

FIGS. 2A-2C illustrate forming a Compute Endpoint Cluster of two nodes. Such an even-numbered cluster is then in need of a witness as a third node in order for the cluster consensus algorithm to operate normally. In the deployment of CEs for HA Clusters, certain scenarios necessitate the presence of a witness entity to ensure proper functioning and security. While software-based witnesses, such as virtual machine (VM)-based or container-based witnesses, offer a convenient alternative to hardware-based solutions, the software-based witnesses inherently introduce security risks that can compromise the overall security posture of the Compute Endpoint HA Cluster. This is particularly problematic for CEs that have been securely onboarded to a MS, such as those utilizing FIDO protocols, where security is paramount. The use of software-based witnesses in these scenarios can undermine the trust and security established during the onboarding process. Therefore, there exists a need for a secure method to deploy and onboard software-based witnesses to a Compute Endpoint HA cluster and to ensure that the software-based witnesses can effectively serve as quorum witnesses without introducing unnecessary security risks. As used herein, the term “witness” refers to a software application that performs roles in an even-node cluster to prevent split-brain scenarios and ensure high availability and data integrity.

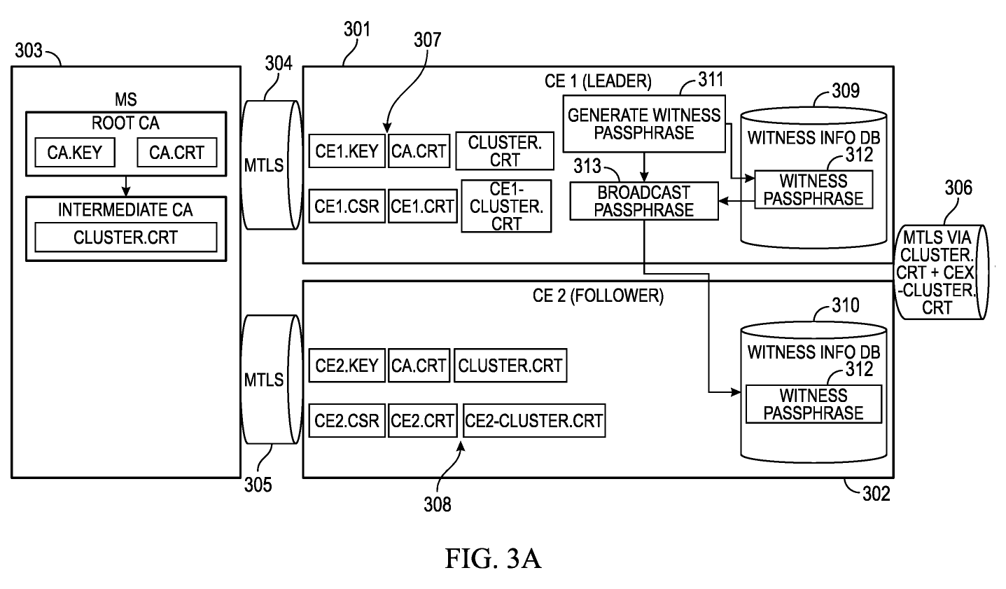

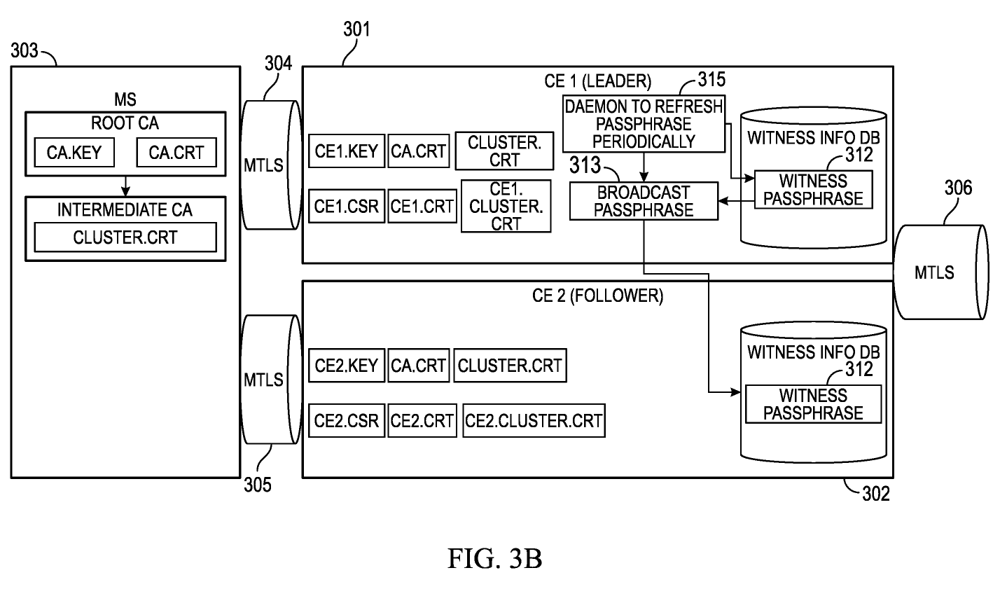

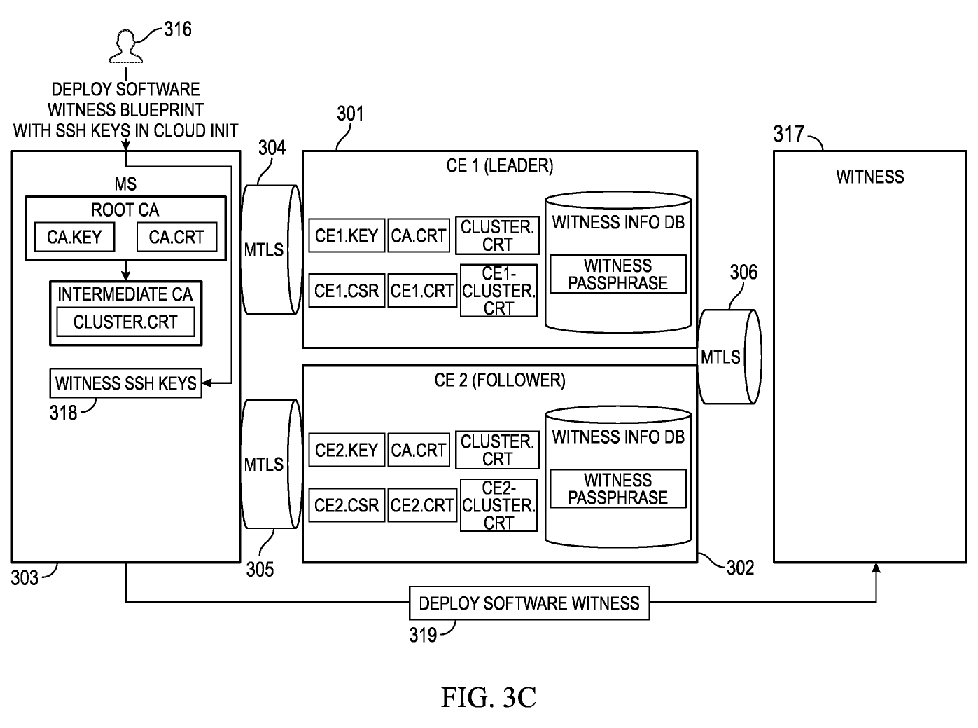

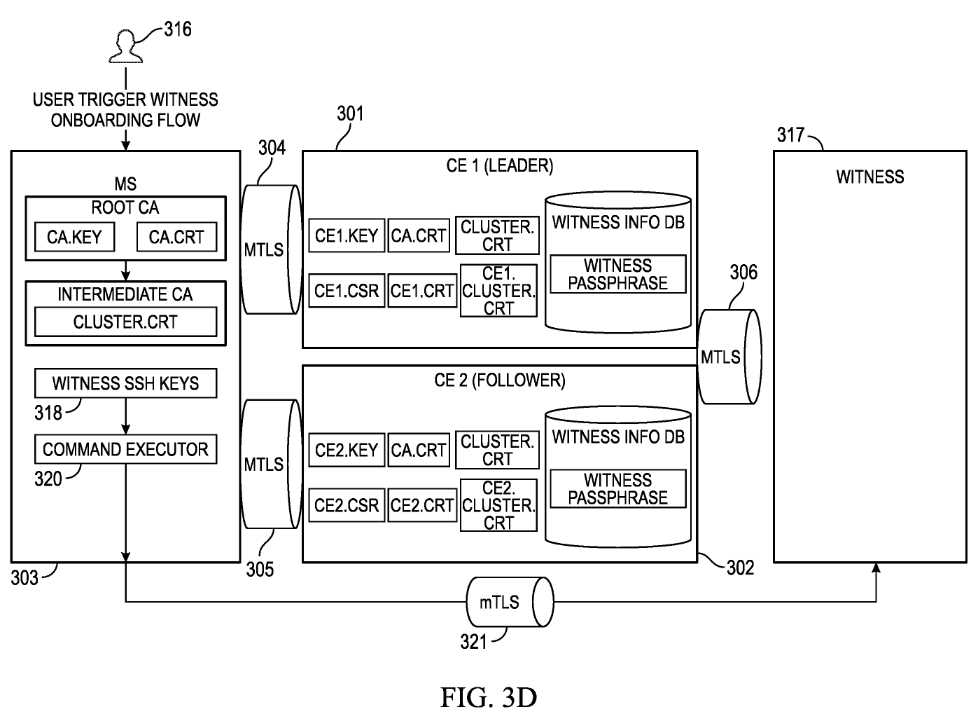

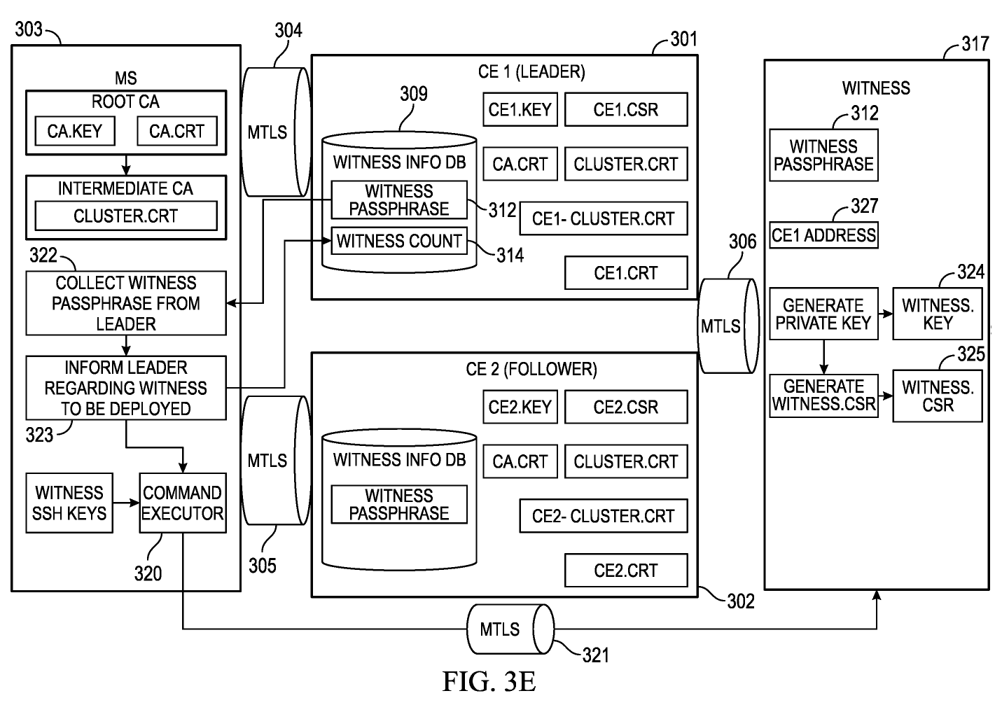

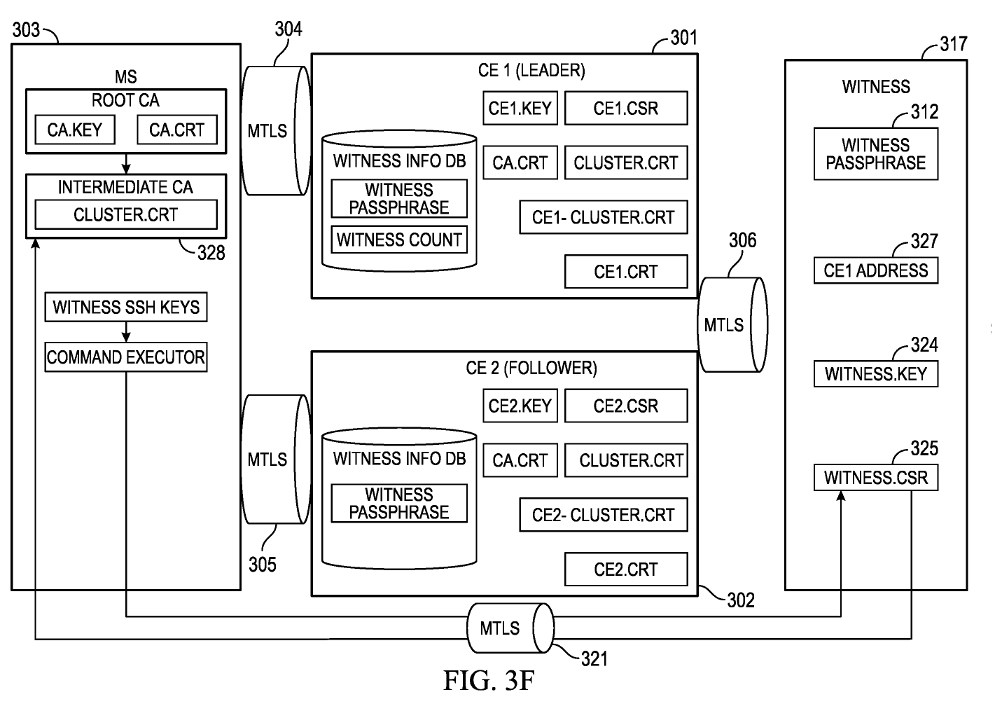

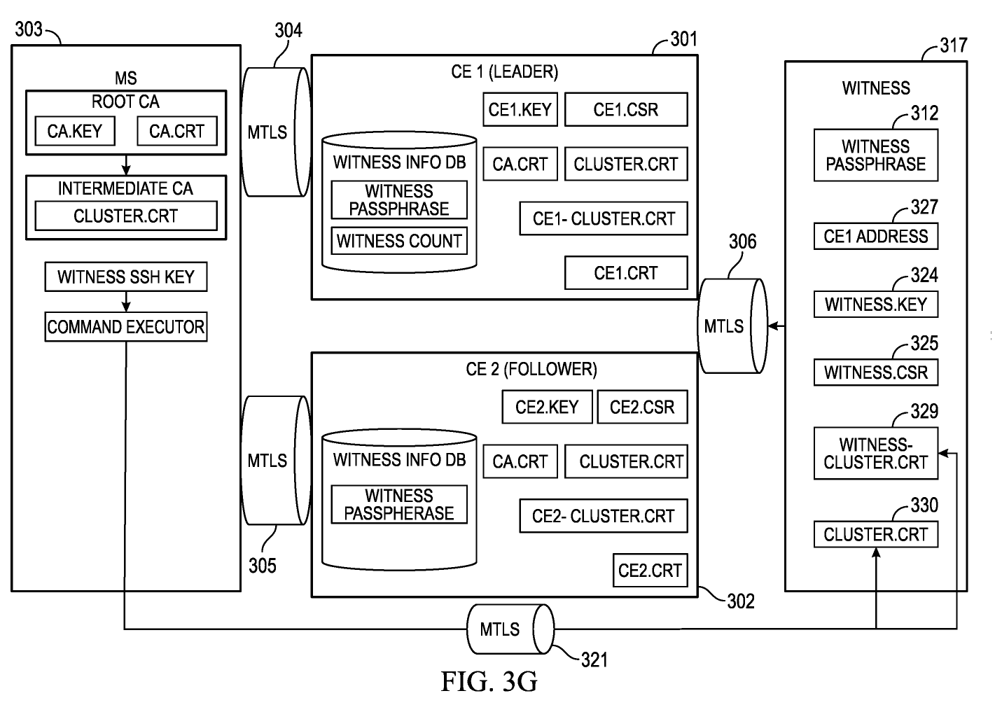

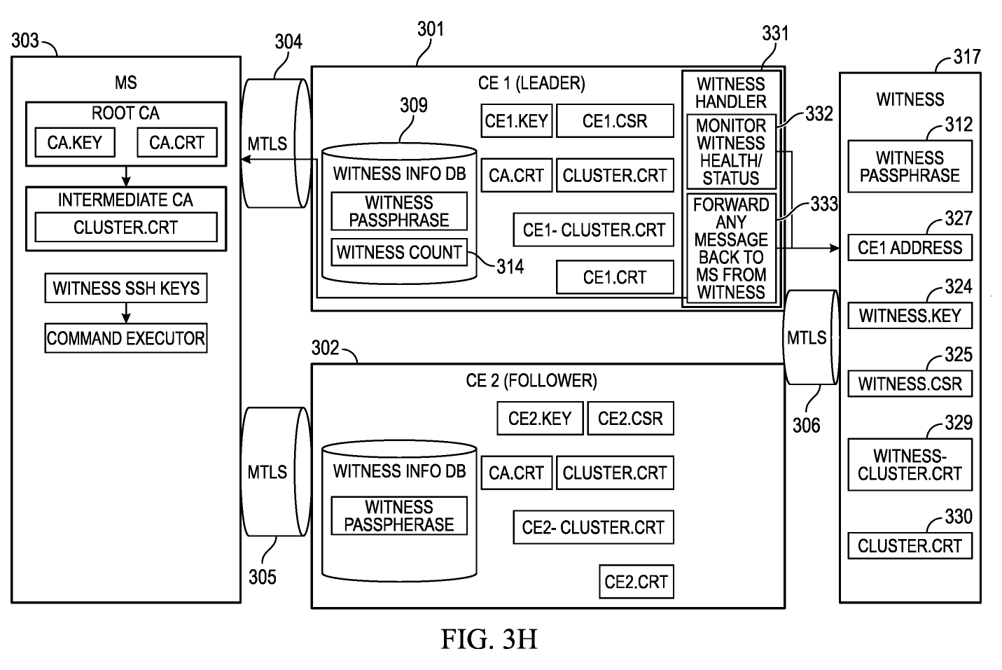

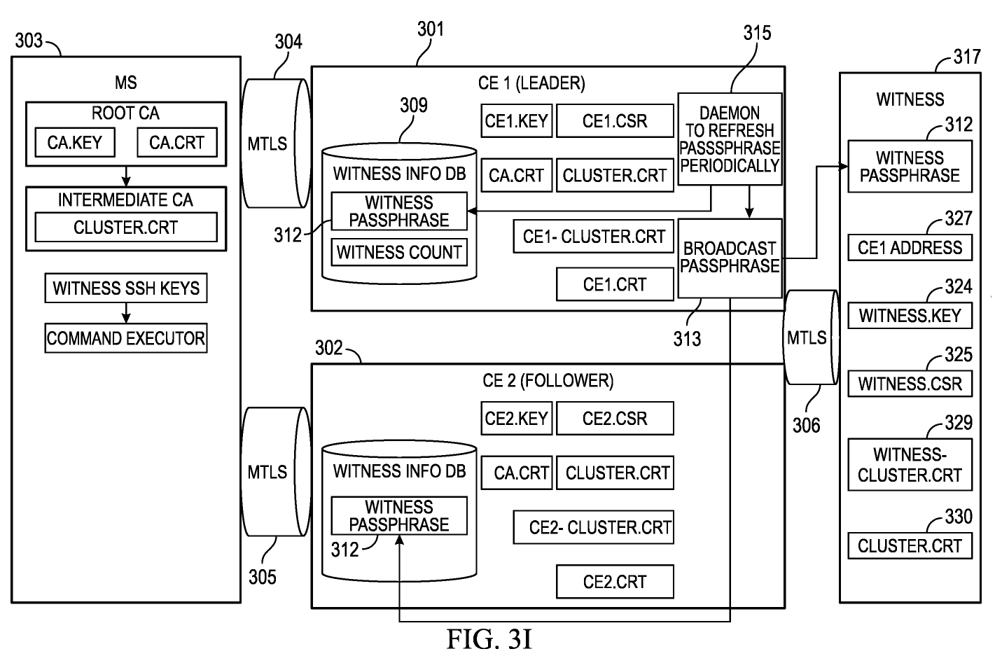

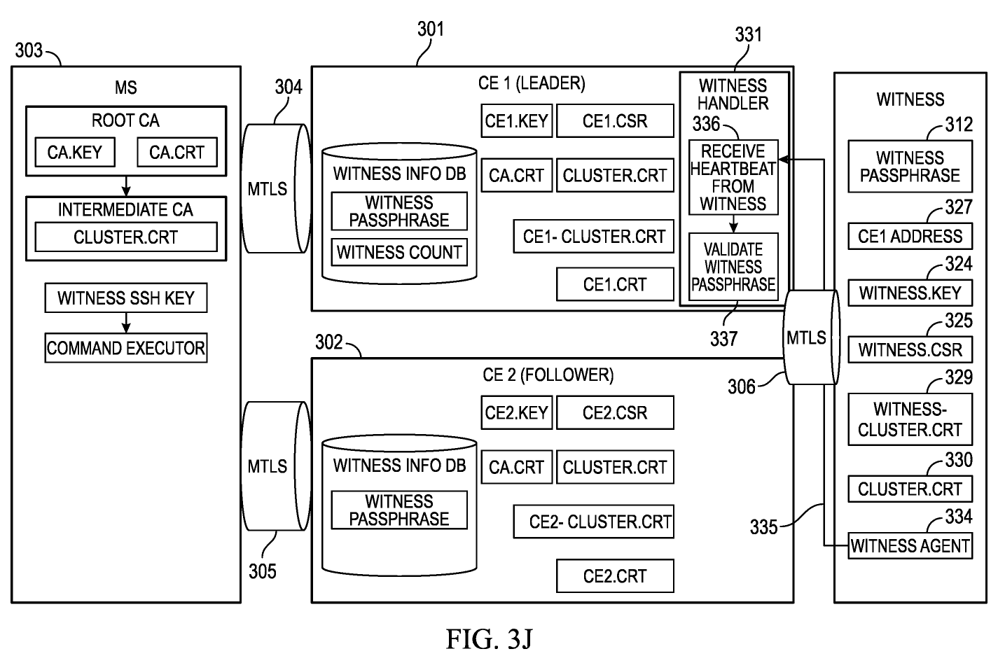

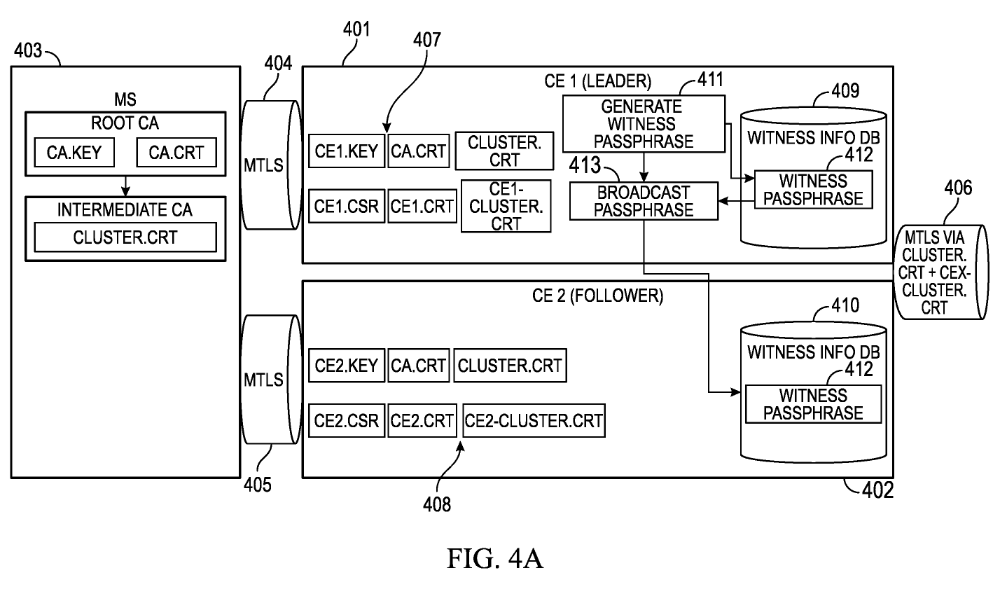

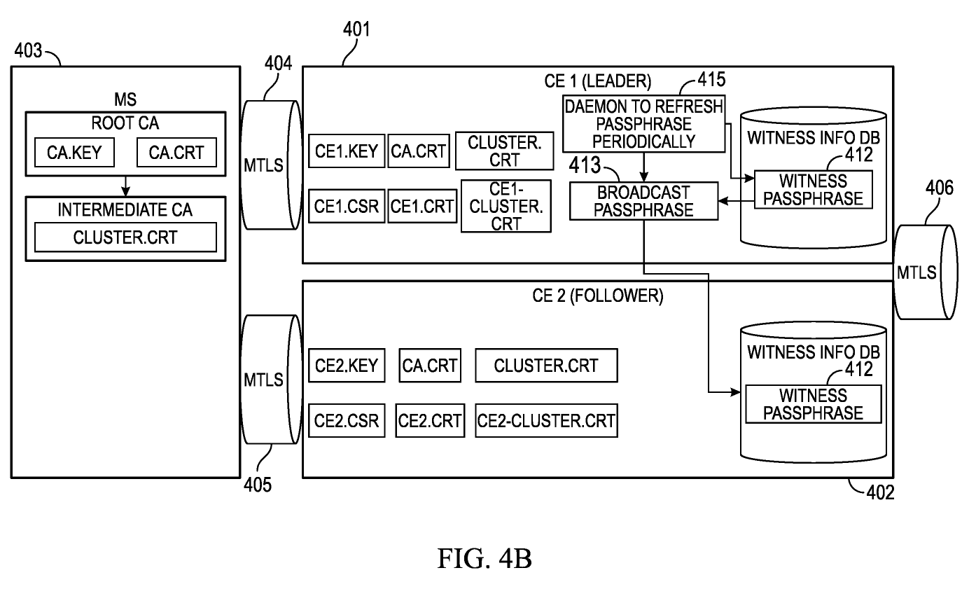

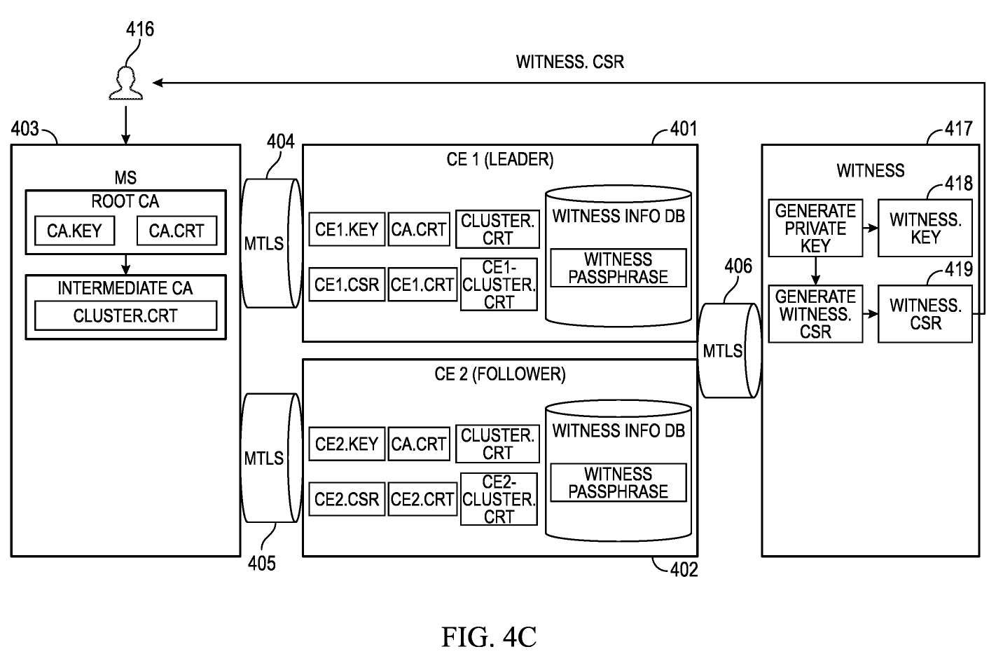

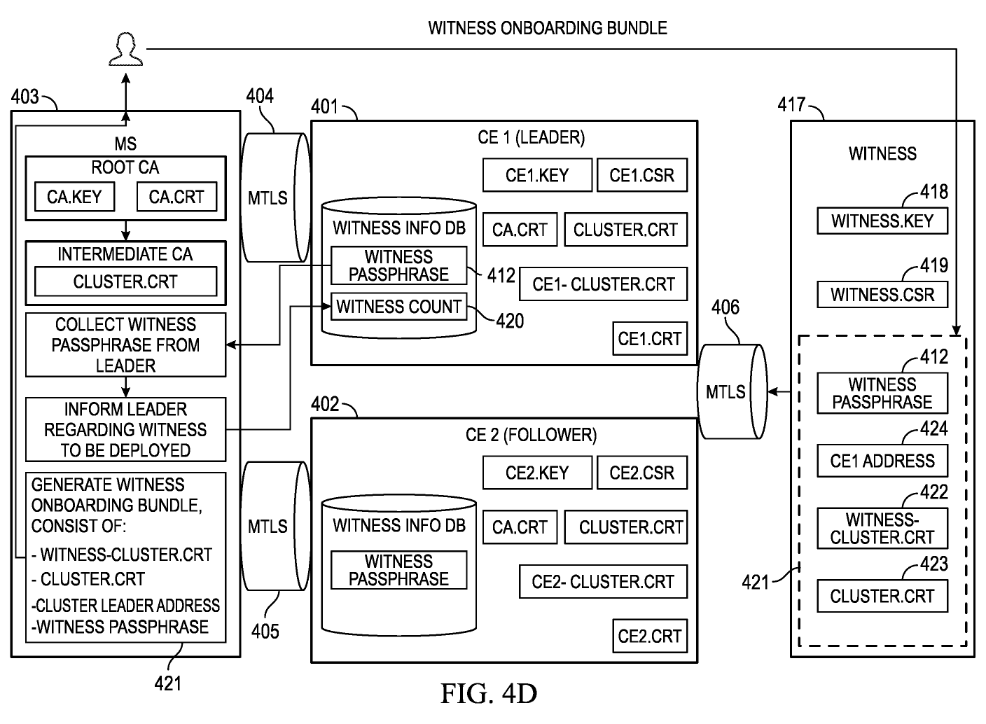

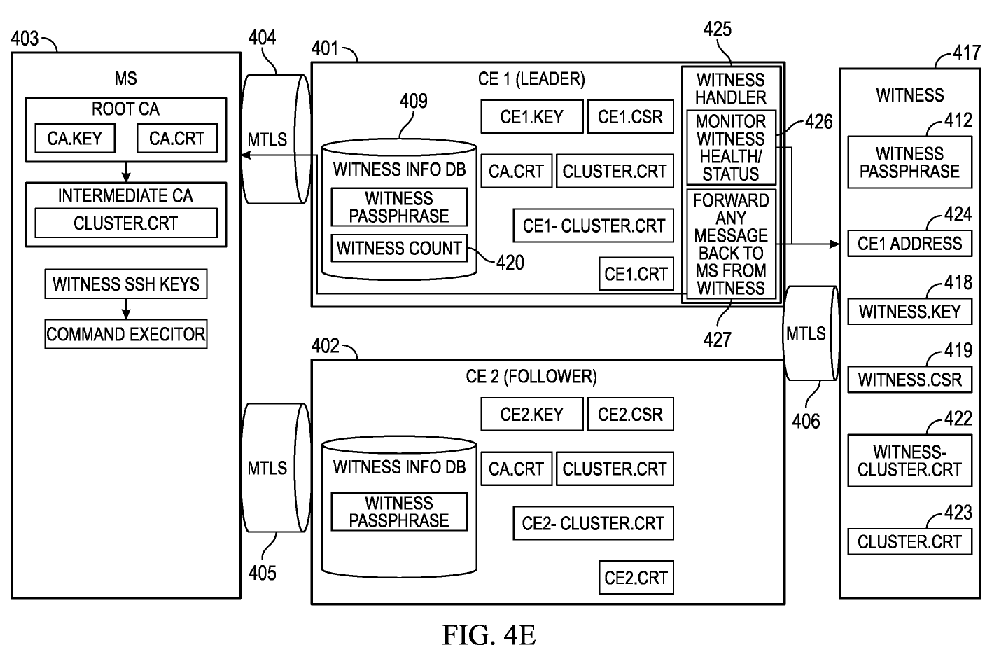

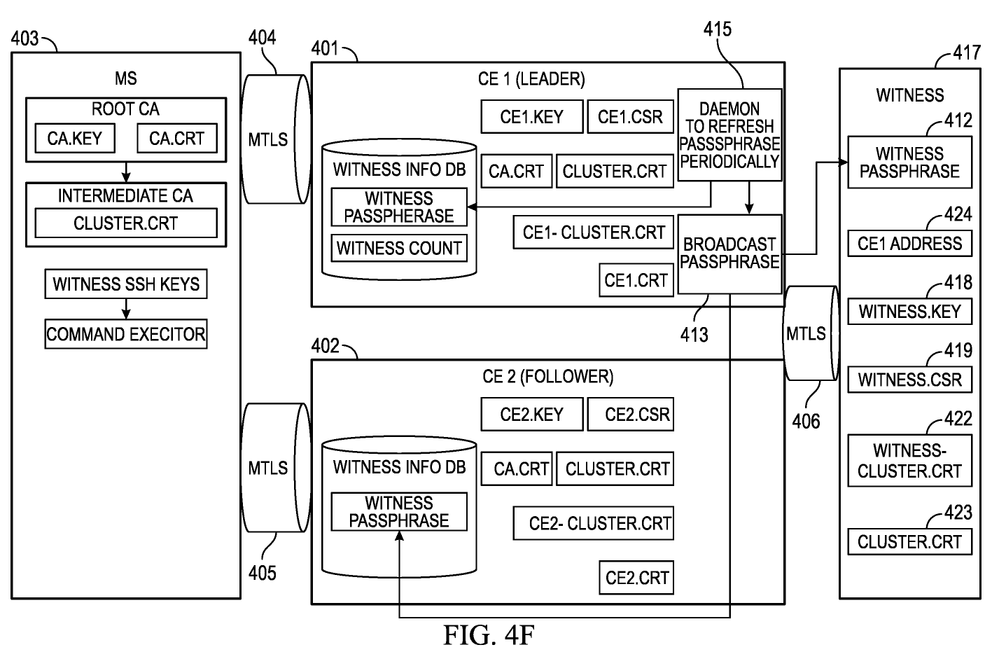

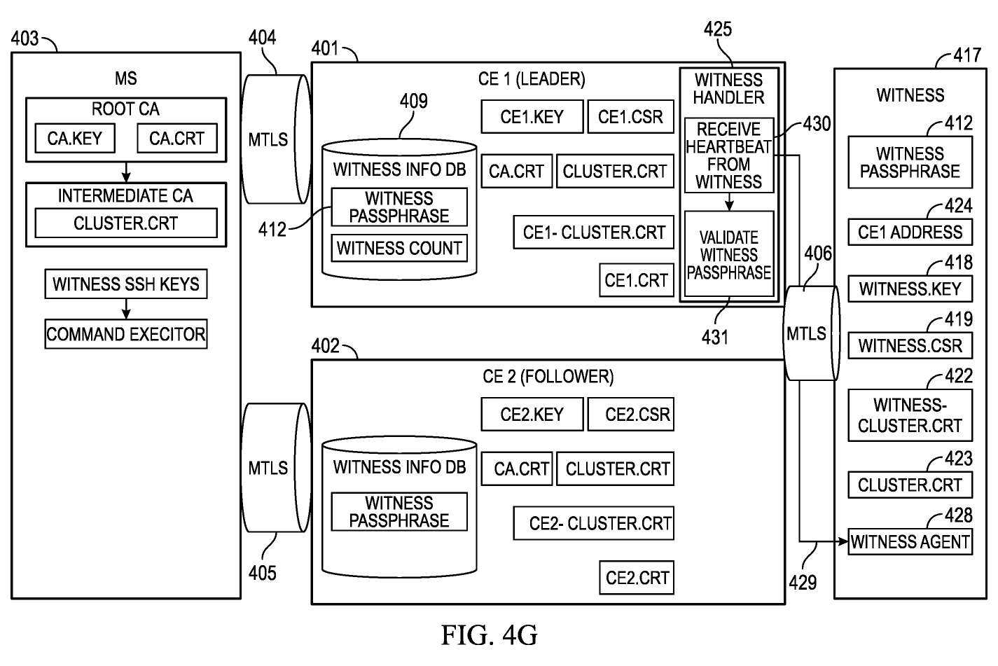

Two alternative solutions are described herein to two distinct scenarios. In a first scenario, direct network access is available between the MS, CEs, and witnesses, including communications initiated from the MS to the CE network. Under this scenario, a full automated solution (i.e. zero touch and automated via the MS-to-CE secure channel) is explained as below in reference to FIGS. 3A-3J. In a second scenario, only indirect network access is available between the MS, CEs, and witnesses. As used herein, indirect means that connectivity is allowed from the CE network to the MS, but not from MS to CE. This is common in edge environments (e.g., between EOs and ECEs) for security reasons. Under this scenario, a secure but non-automated solution is explained as below in reference to FIGS. 4A-4G.

FIG. 3A illustrates an HA cluster comprising CE 301 and CE 302 that has been created by MS 303, such as in the manner described with respect to FIGS. 2A-2C. Each CE 301, 302 has a secure mTLS channel 304, 305 to MS 303. Additionally, a secure inter-CE mTLS channel 306 allows for direct communication among the CEs 301, 302. Communication between CEs over secure channel 306 is accomplished using the public cluster certificate (cluster.crt) and the CE’s own cluster certificate (ceX-cluster.crt).

In this configuration, direct network access is available between MS 303 and CEs 301, 302 wherein MS 303 can deploy VM and container applications to both CEs 301 and 302. The VM and container application may be fully managed by MS 303 or using external systems such as vSphere, Kubernetes or other virtualization or container management platforms. A witness may be packaged as a VM image or a container application. Each CE 301, 302 has the keys and certificates 307, 308 described above for operating in the HA cluster and for using the secure CE channel 306. Additionally, each CE 301, 302 has a witness information database 309, 310.

In the illustrated example, CE 301 has been designated as the leader of the HA cluster, and CE 302 is a follower. After the HA cluster is setup with multiple securely onboarded CEs, the leader of the HA cluster generates a witness passphrase 311 and stores that passphrase 312 in its database 309. Then, the leader 301 then broadcasts 313 the witness passphrase to all other connected followers and witnesses via mTLS communication channel 306. The follower CE 302 stores a copy of the witness passphrase 312 in its database 310.

Referring to FIG. 3B, a daemon 315 running within cluster leader 301 regenerates the witness passphrase periodically. Every time a new passphrase is generated by daemon 315, the new one will replace the previous one stored in leader database 309. Once the witness passphrase is regenerated, the leader will then again broadcast 313 the new passphrase to all other connected followers and witnesses via the mTLS communication channel 306 so that the currently stored witness passphrases 312, 312 are always the current version.

In FIG. 3C, a user 316 logs in to MS 303 and triggers the deployment of witness 317. The witness 317 may be, for example, a VM or container application running on a third CE or a third-party virtualization or container management platform. User 316 generates witness SSH keys 318 on MS 303. SSH keys 318 may be, for example, a pair of public and private keys used for secure authentication and encrypted communication when accessing a remote machine or server. MS 303 then deploys the witness VM or container 317 with witness SSH keys setup 319.

In FIG. 3D, user 316 uses command executor 320 in MS 303 to trigger the witness onboarding flow. A secure channel 321 is established between MS 303 and the witness application 317. The secure channel 321 can be, for example, an SSH connection. To do so, the VM is installed with cloud-init where a SSH public key can be installed. The corresponding SSH private key will never leave MS 303 and will not be exposed, thereby ensuring high level of security. With the secure channel established, MS 303 will perform the witness onboarding flow to the cluster.

In FIG. 3E, as part of the witness onboarding flow, MS 303 first executes a process 322 to collect the witness passphrase 312 from the cluster leader 301. MS 303 also informs 323 the cluster leader 301 that a witness is going to be onboarded to the cluster. Cluster leader 301 then increments a witness count 314. MS 303 runs commands over the secure channel 321 onto the witness 317 VM/container. The commands prompt witness 317 to generate a client private key (witness.key) 324 and using the private key generate a CSR (witness.csr) 325. MS 303 also pushes the witness passphrase 312 and the cluster leader address 327 to the witness 317.

In FIG. 3F, MS 303 retrieves the witness.csr 325. The witness.csr 325 is signed by the intermediate CA 328 in MS 303 using an intermediate CA key. The signed witness. CSR is becomes the witness’s client certificate (witness-cluster.crt).

In FIG. 3G, MS 303 installs the witness-cluster.crt 329 as well as the public cluster.crt 330 on witness 317. With the witness-cluster.crt 329 and cluster.crt 330 in place, witness 317 can establish mTLS communication with both CE 301 and 302 via secure channel 306. This allows the witness to run any consensus algorithm through the secured communication channel 306. The witness-cluster.crt 329 is client certificate for witness 317 and will be used on MS 303 to authenticate witness 317. The cluster.crt 330 is the CA public certificate for MS 303 and will be used by witness 317 to authenticate the MS server certificate.

In FIG. 3H, after witness 317 joins the HA cluster, the cluster leader 301 validates the witness count 314 stored in its database 309. The cluster leader 301 has a witness handler process 331 that is responsible to monitor the health and status 332 of witness 317 because the MS 303 does not have direct connectivity to witness 317. The cluster leader 301 is also responsible for forwarding 333 any relevant messages between witness 317 and MS 303.

As shown in FIG. 3I, the daemon 315 running within cluster leader 301 regenerates the witness passphrase periodically. The regenerated passphrase 312 will be stored locally in the leader database 309 as well as broadcasted 313 to all connected followers 302 and witnesses, including new witness 317 that joined the HA cluster.

In FIG. 3J, a wellness agent 334 on witness 317 is responsible to send a heartbeat message 335 to the cluster leader 301 via the secure mTLS connection 306. This heartbeat message 335 is sent at fixed periods. The heartbeat message 335 contains the most updated witness passphrase 312. Each time the witness handler 331 on cluster leader 301 receives 336 the heartbeat message 335, it continuously validates 337 the passphrase 312 to ensure that the witness 317 is a known witness.

FIG. 4A illustrates an HA cluster comprising CE 401 and CE 402 that has been created by MS 403, such as in the manner described with respect to FIGS. 2A-2C. Each CE 401, 402 has a secure mTLS channel 404, 405 to MS 403. Additionally, a secure inter-CE mTLS channel 406 allows for direct communication among the CEs 401, 402. Communication between CEs over secure channel 406 is accomplished using the public cluster certificate (cluster.crt) and the CE’s own cluster certificate (ceX-cluster.crt).

In the scenario illustrated in FIGS. 3A-3J, it is assumed that the MS can initiate a connection (e.g. an SSH connection) directly to the witness. However, in some network environments, this may not be possible due to firewall restrictions. Such restrictions are typical in edge environments for example. FIGS. 4A-4G illustrate an indirect network access scenario for the situation where the MS cannot connect directly to the witness.

Each CE 401, 402 has the keys and certificates 407, 408 described above for operating in the HA cluster and for using the secure CE channel 406. Additionally, each CE 401, 402 has a witness information database 409, 410. In the illustrated example, CE 401 has been designated as the leader of the HA cluster, and CE 402 is a follower. After the HA cluster is setup with multiple securely onboarded CEs, the leader of the HA cluster generates a witness passphrase 411 and stores that passphrase 412 in its database 409. Then, the leader 401 then broadcasts 413 the witness passphrase to all other connected followers and witnesses via mTLS communication channel 406. The follower CE 402 stores a copy of the witness passphrase 412 in its database 410.

In FIG. 4B, a daemon 415 running within cluster leader 401 regenerates the witness passphrase periodically. Every time a new passphrase is generated by daemon 415, the new one will replace the previous one stored in leader database 409. Once the witness passphrase is regenerated, the leader will then again broadcast 413 the new passphrase to all other connected followers and witnesses via the mTLS communication channel 406 so that the currently stored witness passphrases 412 are always the current version.

In FIG. 4C, a user 416 deploys a software-based witness 417. The deployment of witness 417 may be done manually on a virtualization or container management platforms, such as a user installing a witness VM on a vSphere. Witness 417 generate a client private key (witness.key) 418 and uses the private key generate a CSR (witness.csr) 419. User 416 then retrieves the witness.csr from the witness 417. User 416 can then manually login to user interface for MS 403 using its existing authentication framework (e.g., a username and password). The user 416 can then register the witness 417 to MS 403 by uploading the witness.csr file. Within MS 403, the Cluster CA will then sign this witness.csr to form the witness-cluster.crt.

In FIG. 4D, MS 403 collects the witness passphrase 412 from the cluster leader 401. MS 403 also informs the cluster leader 401 that a witness is going to be onboarded to the cluster and CE 401 updates its witness count 420 to add the new witness 417. MS 403 then generates a witness onboarding bundle 421. The witness onboarding bundle 421 consists of a witness-cluster.crt 422 (i.e., a witness client certificate that will be used on MS 403 to authenticate witness 417), cluster.crt 423 (i.e., the MS 403 CA public certificate that will be used by witness 417 to authenticate the MS server certificate), cluster leader address 424 (for witness 417 to identify which node is the cluster leader, i.e., CE 401), and the witness passphrase 412. User 416 then downloads the witness onboarding bundle 421 from MS 403. User 416 manually logs in to the witness VM/container 417 and imports the witness onboarding bundle 421 to witness 417. With the witness-cluster.crt 422 and cluster.crt 423, witness 417 can establish secure mTLS communication with both CEs 401, 402 and may run any consensus algorithm through the secured communication channel 406.

In FIG. 4E, after witness 417 joins the HA cluster, the cluster leader 401 validates the witness count 430 stored in its database 409. The cluster leader 401 has a witness handler process 425 that is responsible to monitor the health and status 426 of witness 417 because the MS 403 does not have direct connectivity to witness 417. The cluster leader 401 is also responsible for forwarding 427 any relevant messages between witness 417 and MS 403.

As shown in FIG. 4F, the daemon 415 running within cluster leader 401 regenerates the witness passphrase periodically. The regenerated passphrase 412 will be stored locally in the leader database 409 as well as broadcasted 413 to all connected followers 402 and witnesses, including new witness 417 that joined the HA cluster.

In FIG. 4G, a wellness agent 428 on witness 417 is responsible to send a heartbeat message 429 to the cluster leader 401 via the secure mTLS connection 406. This heartbeat message 429 is sent at fixed periods. The heartbeat message 429 contains the most updated witness passphrase 412. Each time the witness handler 425 on cluster leader 401 receives 430 the heartbeat message 429, it continuously validates 431 the passphrase 412 to ensure that the witness 417 is a known witness.

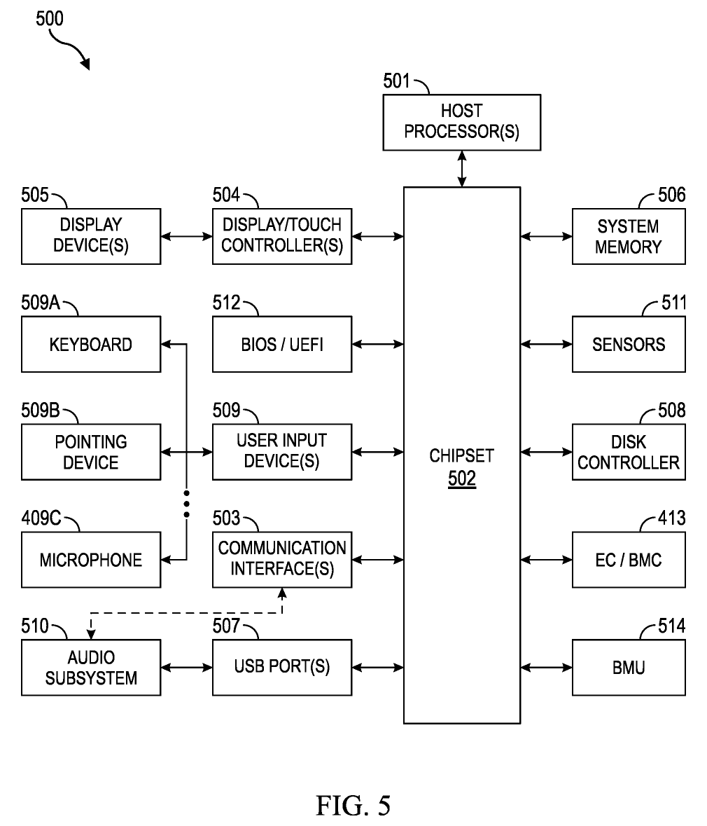

FIG. 5 illustrates an example Information Handling System (IHS) 500 configured to implement systems and methods as described herein for establishing mutual trust between a software-based witness and other CEs of an HA cluster and for ensuring that all entities forming the HA cluster can communicate securely and reliably without introducing unnecessary security risks. IHS 500 may be used as a compute endpoint device 101, 201, 202, 301, 302, 401, or 402 or as a management system 102, 203, 303, or 403. IHS 500 may also be used to host a witness VM or container 317 and 417.

As depicted, IHS 500 includes host processor(s) 501. In various embodiments, IHS 500 may be a single-processor system, or a multi-processor system including two or more processors. Host processor(s) 501 may include any processor capable of executing program instructions, such as an INTEL/AMD x76 processor, or any general-purpose or embedded processor implementing any of a variety of Instruction Set Architectures (ISAs), such as a Complex Instruction Set Computer (CISC) ISA, a Reduced Instruction Set Computer (RISC) ISA (e.g., one or more ARM core(s), or the like).

IHS 500 includes chipset 502 coupled to host processor(s) 501. Chipset 502 may provide host processor(s) 501 with access to resources. In some cases, chipset 502 may utilize a QuickPath Interconnect (QPI) bus to communicate with host processor(s) 501. Chipset 502 may also be coupled to communication interface(s) 503 to enable communications between IHS 500 and various wired and/or wireless networks, such as Ethernet, WiFi (IEEE 802.11), Bluetooth (IEEE 802.15.1), cellular or mobile networks (e.g., Code-Division Multiple Access or “CDMA,” Time-Division Multiple Access or “TDMA,” Long-Term Evolution or “LTE,” etc.), satellite networks, or the like. Communication interface(s) 503 may be used to communicate with peripheral devices (e.g., Bluetooth speakers, microphones, headsets, etc.). Moreover, communication interface(s) 503 may be coupled to chipset 502 via a Peripheral Component Interconnect Express (PCIe) bus, or the like.

Chipset 502 may be coupled to display and/or touchscreen controller(s) 504, which may include one or more Graphics Processor Units (GPUs) on a graphics bus, such as an Accelerated Graphics Port (AGP) or PCIe bus. As shown, display controller(s) 504 provide video or display signals to one or more display device(s) 505. Display device(s) 505 may include Liquid Crystal Display (LCD), Light Emitting Diode (LED), Organic LED (OLED), or other thin film display technologies. Display device(s) 505 may include a plurality of pixels arranged in a matrix, configured to display visual information, such as text, two-dimensional images, video, three-dimensional images, etc. In some cases, display device(s) 505 may be provided as a single continuous display, rather than two discrete displays.

Chipset 502 may provide host processor(s) 501 and/or display controller(s) 504 with access to system memory 506. In various embodiments, system memory 506 may be implemented using any suitable memory technology, such as static RAM (SRAM), dynamic RAM (DRAM) or magnetic disks, or any nonvolatile/Flash-type memory, such as a Solid-State Drive (SSD), Non-Volatile Memory Express (NVMe), or the like.

In certain embodiments, chipset 502 may also provide host processor(s) 501 with access to one or more Universal Serial Bus (USB) ports/controllers 507, to which one or more peripheral devices may be coupled (e.g., integrated or external webcams, microphones, speakers, etc.).

Chipset 502 may further provide host processor(s) 501 with access to a disk controller 508, which may include a disk interface that connects the disc controller 508 to a Hard Disk Drive (HDD), an Optical Disk Drive (ODD), an SSD, and/or a disk emulator. The disk interface may include, for example, an Integrated Drive Electronics (IDE) interface, an Advanced Technology Attachment (ATA) such as a parallel ATA (PATA) interface or a serial ATA (SATA) interface, a SCSI interface, a USB interface, a proprietary interface, or a combination thereof. The disk emulator may be provide an external interface that permits one or more hard disk drives, solid-state drives, optical drives, or other removable-media drives to be connected to IHS 500. An example of external interface includes a USB interface, an IEEE 1394 (Firewire) interface, a proprietary interface, or a combination thereof.

Chipset 502 may also provide access to one or more user input devices 509, for example, using a super I/O controller or the like. Examples of user input devices 509 include, but are not limited to, a keyboard 509a, pointing device 509b, such as a mouse, trackball, stylus, or active pen, and/or microphone(s) 509c. Other user input devices 509 (not shown) may include a camera, touchpad, totem, etc. Each user input device 509 may include a respective controller (e.g., a touchpad may have its own touchpad controller) that interfaces with chipset 502 through a wired or wireless connection, for example via communication interfaces(s) 503 and/or USB port(s) 507. Other input devices, such as keyboard 509a, may use a keyboard controller in an operating system.

In some cases, chipset 502 may also provide access to one or more output devices, such as an audio subsystem 510, speakers, headsets, video projectors, paper printers, 3D printers, Virtual/Augmented Reality (VR/AR) devices, etc. The output devices may be accessed, for example, via communication interfaces(s) 503 and/or USB port(s) 507. Audio subsystem 510 may include speakers, which comprise any system, device, or apparatus configured to produce sound in response to electrical audio signal input. In some embodiments, a speaker may comprise a dynamic loudspeaker, which employs a lightweight diaphragm mechanically coupled to a rigid frame via a flexible suspension that constrains a voice coil to move axially through a cylindrical magnetic gap such that when an electrical signal is applied to the voice coil, a magnetic field is created by the electric current in the voice coil, making it a variable electromagnet. The coil and the driver's magnetic system interact, generating a mechanical force that causes the coil (and thus, the attached cone) to move back and forth, thereby reproducing sound under the control of the applied electrical signal coming from the amplifier.

In certain embodiments, chipset 502 may further provide an interface for communications with one or more hardware sensors 511. Sensors 511 may be disposed on or within the chassis of IHS 500, or otherwise coupled to IHS 500, and may include, but are not limited to: electric, magnetic, radio, optical (e.g., camera, webcam, etc.), infrared, thermal, force, pressure, acoustic (e.g., microphone), ultrasonic, proximity, position, deformation, bending, direction, movement, velocity, rotation, gyroscope, Inertial Measurement Unit (IMU), and/or acceleration sensor(s).

A Basic Input and Output System/Unified Extensible Firmware Interface (BIOS/UEFI) 512 is coupled to chipset 502. UEFI was designed as a successor to BIOS, and many modern IHSs utilize UEFI in addition to or instead of a BIOS. Accordingly, BIOS/UEFI 512 is intended to also encompass a UEFI component. BIOS/UEFI 512 provides an abstraction layer that allows the OS to interface with certain hardware components that are utilized by IHS 500. Upon booting of IHS 500, host processor(s) 501 may utilize program instructions of BIOS 512 to initialize and test hardware components coupled to IHS 500, and to load a host OS for use by IHS 500. Via the hardware abstraction layer provided by BIOS/UEFI 512, software stored in system memory 506 and executed by host processor(s) 501 can interface with I/O devices coupled to IHS 500.

An Embedded Controller (EC) 513 (sometimes referred to as a Baseboard Management Controller or “BMC”) includes a microcontroller unit or processing core dedicated to handling selected IHS operations not ordinarily handled by host processor(s) 501. Examples of such operations may include, but are not limited to: power sequencing, power management, receiving and processing signals from a keyboard or touchpad, as well as other buttons and switches (e.g., power button, laptop lid switch, etc.), receiving and processing thermal measurements (e.g., performing cooling fan control, throttling CPUs and GPUs, controlling colling fan speeds, and emergency shutdown), controlling indicator Light-Emitting Diodes (LEDs) (e.g., caps lock, scroll lock, num lock, battery, ac, power, wireless LAN, sleep, etc.), managing the battery charger and the battery, enabling remote or Out-of-Band (OOB) management, diagnostics, and remediation over network(s), and the like.

Unlike other devices in IHS 500, EC 513 may be made operational from the very start of each power reset, before other devices are fully running or powered on. As such, EC 513 may be responsible for interfacing with a power adapter to manage the power consumption of IHS 500. These operations may be utilized to determine the power status of IHS 500, such as whether IHS 500 is operating from battery power or is plugged into an AC power source. Firmware instructions utilized by EC 513 may be used to manage other core operations of IHS 500 (e.g., turbo modes, maximum operating clock frequencies of certain components, etc.).

In some cases, EC 513 may implement operations for detecting certain changes to the physical configuration or posture of IHS 500 and managing other devices in different configurations of IHS 500. For instance, when IHS 500 as a 2-in-1 laptop/tablet form factor, EC 513 may receive inputs from a lid position or hinge angle sensor 511, and it may use those inputs to determine: whether the two sides of IHS 500 have been latched together to a closed position or a tablet position, the magnitude of a hinge or lid angle, etc. In response to these changes, the EC may enable or disable certain features of IHS 500 (e.g., front or rear facing camera, etc.).

In some implementations, EC 513 may be installed as a Trusted Execution Environment (TEE) component to the motherboard of IHS 500. Additionally, or alternatively, EC 513 may be further configured to calculate hashes or signatures that uniquely identify individual components of IHS 500. In such scenarios, EC 513 may calculate a hash value based on the configuration of a hardware and/or software component coupled to IHS 500. For instance, EC 513 may calculate a hash value based on all firmware and other code or settings stored in an onboard memory of a hardware component.

In addition, EC 513 may provide an Out-of-Band communication channel that allows an Information Technology Decision Maker (ITDM) or Original Equipment Manufacturer (OEM) to manage IHS 500’s various settings and configurations, for example, by issuing OOB commands.

In various embodiments, IHS 500 may be coupled to an external power source through an AC adapter, power brick, or the like. The AC adapter may be removably coupled to a battery charge controller to provide IHS 500 with a source of DC power provided by battery cells of a battery system in the form of a battery pack (e.g., a lithium ion or “Li-ion” battery pack, or a nickel metal hydride or “NiMH” battery pack including one or more rechargeable batteries). Battery Management Unit (BMU) 514 may be coupled to EC 513 and it may include, for example, an Analog Front End (AFE), storage (e.g., non-volatile memory), and a microcontroller. In some cases, BMU 514 may be configured to collect and store information, and to provide that information to other IHS components.

Examples of information collectible by BMU 514 may include, but are not limited to: operating conditions (e.g., battery operating conditions including battery state information such as battery current amplitude and/or current direction, battery voltage, battery charge cycles, battery state of charge, battery state of health, battery temperature, battery usage data such as charging and discharging data; and/or IHS operating conditions such as processor operating speed data, system power management and cooling system settings, state of “system present” pin signal), environmental or contextual information or state (e.g., such as ambient temperature, relative humidity, system geolocation measured by GPS or triangulation, time and date, etc.), events, etc. Examples of events may include, but are not limited to: acceleration or shock events, system transportation events, exposure to elevated temperature for extended time periods, high discharge current rate, combinations of battery voltage, battery current and/or battery temperature (e.g., elevated temperature event at full charge and/or high voltage causes more battery degradation than lower voltage), etc.

In some embodiments, IHS 500 may not include all the components shown in FIG. 5. Furthermore, some components that are represented as separate components in FIG. 5 may instead be integrated with other components, such that all or a portion of the operations executed by the illustrated components may instead be executed by the integrated component. For example, in various embodiments described herein, host processor(s) 501 and/or other components shown in FIG. 5 (e.g., chipset 502, display controller(s) 504, communication interface(s) 503, EC 513, etc.) may be replaced by other devices. As such, IHS 500 may assume different form factors including, but not limited to: servers, workstations, desktops, laptops, appliances, video game consoles, tablet computers, smartphones, etc.

In an example embodiment, a method comprises configuring a cluster of compute endpoints using a management system, deploying a witness entity, establishing a secure communication channel between the management system and the witness entity, generating a witness certificate signing request (CSR) on the witness entity, signing the witness CSR by the management system to create a witness-cluster certificate, providing the witness-cluster certificate and a cluster certificate to the witness entity from the management system, and establishing secure communication channels between the witness entity and the compute endpoints using the witness-cluster certificate and the cluster certificate. The method may further comprise joining the witness entity to the cluster, and running a consensus algorithm through the secure communication channels between the witness entity and the compute endpoints. Signing the witness CSR may comprise retrieving the witness CSR from the witness entity by the management system, and signing the witness CSR using an intermediate certificate authority (CA) of the management system. The witness entity may be a virtual machine (VM)-based or container-based software application.

The method may further comprise notifying a cluster leader endpoint that the witness will be onboarded to the cluster, and updating a witness count on the cluster leader endpoint.

The method may further comprise generating a witness passphrase at a cluster leader endpoint, and distributing the witness passphrase to other endpoints in the cluster. The method further comprising collecting the witness passphrase from the cluster leader by the management system, and providing the witness passphrase to the witness entity by the management system. The method further comprising refreshing the witness passphrase periodically by the cluster endpoint leader, and distributing a refreshed witness passphrase to the witness entity and other endpoints in the cluster. The method further comprising receiving a heartbeat message at a cluster leader endpoint from the witness entity, the heartbeat message comprising a passphrase, and validating the passphrase in the heartbeat message to confirm that the witness entity as a member of the cluster.

Another example method comprises configuring a cluster of compute endpoints using a management system, deploying a witness entity by a user wherein the witness entity does not have a communication channel with the management system, generating a witness certificate signing request (CSR) on the witness entity, providing the witness CSR to the management system by the user, signing the witness CSR by the management system to create a witness-cluster certificate, providing the witness-cluster certificate and a cluster certificate to the witness entity by the user, and establish secure communication channels between the witness entity and the compute endpoints using the witness-cluster certificate and the cluster certificate. The method further comprising providing a cluster leader endpoint address and a witness passphrase to the witness entity by the user. The witness-cluster certificate, the cluster certificate, the cluster leader endpoint address, and the witness passphrase are provided to the witness entity by the user as an onboarding bundle.

The method may further comprise joining the witness entity to the cluster, and running a consensus algorithm through the secure communication channels between the witness entity and the compute endpoints.

The witness entity may be a virtual machine (VM)-based or container-based software application.

The method further comprising generating a witness passphrase at a cluster leader endpoint, and distributing the witness passphrase to other endpoints in the cluster. The method further comprising collecting the witness passphrase from the cluster leader by the management system, and providing the witness passphrase to the witness entity by the management system.

An example system comprises a management system configured to manage operation of servers, and a plurality of servers in communication with the management system. The management system comprises a processor and a memory coupled to the processor. The memory has program instructions stored thereon that, upon execution, cause the processor to configure a cluster comprising two or more of the servers, deploy a witness entity, establish a secure communication channel between the management system and the witness entity, retrieve a witness certificate signing request (CSR) directly from the witness entity, sign the witness CSR to create a witness-cluster certificate, provide the witness-cluster certificate and a cluster certificate to the witness entity, and establish secure communication channels between the witness entity and the cluster servers using the witness-cluster certificate and the cluster certificate.

At least one server in the system further comprises a processor and a memory coupled to the processor. The memory has program instructions stored thereon that, upon execution, cause the processor to generate a witness passphrase, periodically refresh the witness passphrase, and broadcast the witness passphrase to the servers in the cluster and to the witness.

At least one server in the system further comprises a processor and a memory coupled to the processor. The memory has program instructions stored thereon that, upon execution, cause the processor to: receive a heartbeat message from the witness entity, and monitor the health and status of the witness entity. The witness entity is a virtual machine (VM)-based or container-based software application.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated that the conception and specific embodiment disclosed may be readily utilized as a basis for modifying or designing other structures for carrying out the same purposes of the present invention. It should also be realized that such equivalent constructions do not depart from the invention set forth in the appended claims. The novel features which are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

What is claimed is:

1. A method, comprising:
configuring a cluster of compute endpoints using a management system;
deploying a witness entity;
establishing a secure communication channel between the management system and the witness entity;
generating a witness certificate signing request (CSR) on the witness entity;
signing the witness CSR by the management system to create a witness-cluster certificate;
providing the witness-cluster certificate and a cluster certificate to the witness entity from the management system; and
establishing secure communication channels between the witness entity and the compute endpoints using the witness-cluster certificate and the cluster certificate.

2. The method of claim 1, further comprising:
joining the witness entity to the cluster; and
running a consensus algorithm through the secure communication channels between the witness entity and the compute endpoints.

3. The method of claim 1, wherein signing the witness CSR comprises:
retrieving the witness CSR from the witness entity by the management system; and
signing the witness CSR using an intermediate certificate authority (CA) of the management system.

4. The method of claim 1, further comprising:
notifying a cluster leader endpoint that the witness will be onboarded to the cluster; and
updating a witness count on the cluster leader endpoint.

5. The method of claim 1, wherein the witness entity is a virtual machine (VM)-based or container-based software application.

6. The method of claim 1, further comprising:
generating a witness passphrase at a cluster leader endpoint; and
distributing the witness passphrase to other endpoints in the cluster.

7. The method of claim 6, further comprising:
collecting the witness passphrase from the cluster leader by the management system; and
providing the witness passphrase to the witness entity by the management system.

8. The method of claim 6, further comprising:
refreshing the witness passphrase periodically by the cluster endpoint leader; and
distributing a refreshed witness passphrase to the witness entity and other endpoints in the cluster.

9. The method of claim 6, further comprising:
receiving a heartbeat message at a cluster leader endpoint from the witness entity, the heartbeat message comprising a passphrase; and
validating the passphrase in the heartbeat message to confirm that the witness entity as a member of the cluster.

10. A method, comprising:
configuring a cluster of compute endpoints using a management system;
deploying a witness entity by a user wherein the witness entity does not have a communication channel with the management system;
generating a witness certificate signing request (CSR) on the witness entity;
providing the witness CSR to the management system by the user;
signing the witness CSR by the management system to create a witness-cluster certificate;
providing the witness-cluster certificate and a cluster certificate to the witness entity by the user; and
establish secure communication channels between the witness entity and the compute endpoints using the witness-cluster certificate and the cluster certificate.

11. The method of claim 10, further comprising:
providing a cluster leader endpoint address and a witness passphrase to the witness entity by the user.

12. The method of claim 11, wherein the witness-cluster certificate, the cluster certificate, the cluster leader endpoint address, and the witness passphrase are provided to the witness entity by the user as an onboarding bundle.

13. The method of claim 10, further comprising:
joining the witness entity to the cluster; and
running a consensus algorithm through the secure communication channels between the witness entity and the compute endpoints.

14. The method of claim 10, wherein the witness entity is a virtual machine (VM)-based or container-based software application.

15. The method of claim 10, further comprising:
generating a witness passphrase at a cluster leader endpoint; and
distributing the witness passphrase to other endpoints in the cluster.

16. The method of claim 15, further comprising:
collecting the witness passphrase from the cluster leader by the management system; and
providing the witness passphrase to the witness entity by the management system.

17. A system, comprising:
a management system configured to manage operation of servers; and
a plurality of servers in communication with the management system;
the management system comprising:
a processor; and
a memory coupled to the processor, the memory having program instructions stored thereon that, upon execution, cause the processor to:
configure a cluster comprising two or more of the servers;
deploy a witness entity;
establish a secure communication channel between the management system and the witness entity;
retrieve a witness certificate signing request (CSR) directly from the witness entity;
sign the witness CSR to create a witness-cluster certificate;
provide the witness-cluster certificate and a cluster certificate to the witness entity; and
establish secure communication channels between the witness entity and the cluster servers using the witness-cluster certificate and the cluster certificate.

18. The system of claim 17, wherein at least one server further comprises:
a processor; and
a memory coupled to the processor, the memory having program instructions stored thereon that, upon execution, cause the processor to:
generate a witness passphrase;
periodically refresh the witness passphrase; and
broadcast the witness passphrase to the servers in the cluster and to the witness.

19. The system of claim 17, wherein at least one server further comprises:
a processor; and
a memory coupled to the processor, the memory having program instructions stored thereon that, upon execution, cause the processor to:
receive a heartbeat message from the witness entity; and
monitor the health and status of the witness entity.

20. The system of claim 17, wherein the witness entity is a virtual machine (VM)-based or container-based software application.
